(19) United States
(12) Patent Application Publication
(10) Pub. No.: US 2026/0048940 A1
(43) Pub. Date: Feb. 19, 2026

(54) SYSTEM AND METHOD FOR FULFILLING A GROUP ORDER USING BUNDLED TOTE

(71) Applicant: TWINNY CO., LTD., Daejeon (KR)

(72) Inventors: Hyeong Cheol MOON, Daejeon (KR); Seol Hee JEON, Daejeon (KR)

(73) Assignee: TWINNY CO., LTD., Daejeon (KR)

(21) Appl. No.: 18/922,462

(22) Filed: Oct. 22, 2024

Related U.S. Application Data
(63) Continuation of application No. PCT/KR2024/015780, filed on Oct. 17, 2024.

(30) Foreign Application Priority Data
Aug. 16, 2024 (KR) 10-2024-0109708

(51) Int. Cl. B65G 1/137; G05D 1/667; G05D 105/20; G05D 107/70; G05D 111/30

(52) U.S. Cl. CPC B65G 1/1373; G05D 1/667; B65G 2201/0258; B65G 2209/02; G05D 2105/20; G05D 2107/70; G05D 2111/32

(57) ABSTRACT

A method for fulfilling a group order using a bundled tote is disclosed. The order fulfillment method using the bundled tote includes generating, by a first processor, order information in which a first type of a first bundled tote and the group order link each other; transmitting, by the first processor, the order information to the robot; when the second bundled tote is already loaded on the robot, determining, by a second processor, whether a type of the second bundled tote corresponds to the type of the first bundled tote of the order information; and fulfilling, by the second processor, the group order without replacing the second bundled tote, if it corresponds.

### CROSS REFERENCE TO THE RELATED APPLICATIONS

This application is the continuation application of International Application No. PCT/KR2024/015780, filed on Oct. 17, 2024, which is based upon and claims priority to Korean Patent Application No. 10-2024-0109708, filed on Aug. 16, 2024, the entire contents of which are incorporated herein by reference.

### TECHNICAL FIELD

The present invention relates to a system and method for fulfilling an order using a bundled tote.

### BACKGROUND

An order for an item includes picking and packaging the item and then requesting delivery it to a specific address. The picking may mean selecting and taking out the ordered item from the warehouse.

In a large warehouse, fulfilling an order includes picking and transporting the item during the fulfillment of the order, and this work may be done by a picking robot. The picking robot may load a basket called a tote which containing the item, and the selected item is contained in the tote and transported by the picking robot.

Two or more totes may be grouped and used. The grouped totes may be called a bundled tote. The bundled tote provides the convenience of transporting a plurality of items by a single robot.

Minimization of working time is an important issue in selecting and transporting the items using the picking robot. To this end, a method for optimizing the moving path of the robot to move to pick various items, and a method for appropriately distributing and assigning orders to various robots to minimize idle robots have been major research topics.

### SUMMARY

The technical problem to be solved by the present invention is to provide an order fulfillment system using a bundled tote and an order fulfillment method using the bundled tote, which can contribute to minimizing an order fulfillment time by minimizing the time for replacing the bundled tote.

In order to solve the above technical problem, a method for fulfilling a group order in a system including a first processor of a server and a second processor of a robot according to an embodiment of the present invention, the method may include generating, by the first processor, order information in which a type of a first bundled tote and the group order link each other; transmitting, by the first processor, the order information to the robot; determining, by at least one of the first processor and the second processor, whether a type of a second bundled tote corresponds to the type of the first bundled tote of the order information when the second bundled tote is loaded on the robot; and fulfilling, by the second processor, the group order without replacing the second bundled tote which is loaded on the robot, if it corresponds.

In an embodiment of the present invention, the method may further include transmitting, by the second processor, an information on the second bundled tote to the server.

In an embodiment of the present invention, the method may further include displaying, by the second processor, a request information for using continuously the second bundled tote.

In an embodiment of the present invention, the order information may be multiple order information in which different group orders are respectively linked with respect to the same type of the first bundled tote, the method may further include transmitting, by the second processor, the information on the second bundled tote to the server so that the multiple order information and the information on the second bundled tote linking each other; controlling, by the second processor, the robot to move to a drop-off spot to complete the fulfillment of any one group order; and displaying, by the second processor, the request information for using continuously the second bundled tote.

In an embodiment of the present invention, the order information may be multiple order information in which different group orders and one or more types of the first bundled tote link each other respectively, the method may further include receiving, by the second processor, the order information and determining a fulfillment order for the plurality of group orders so that the group orders may be sequentially fulfilled using the same second bundled tote; transmitting, by the second processor, the information on the second bundled tote to the server so that the information on the second bundled tote is linked with the plurality of group orders which may be fulfilled with the same type of the first bundled tote among the plurality of group orders in an order in which the group orders may be sequentially fulfilled using the same second bundled tote; controlling, by the second processor, the robot to move to a drop-off spot to complete the fulfillment of any one group order being fulfilled; and displaying, by the second processor, the request information for using continuously the second bundled tote.

In addition, in order to solve the above technical problem, a method for fulfilling a group order in a system including a processor of a robot loaded with a first bundled tote according to an embodiment of the present invention, the method may include controlling, by the processor, the robot to move to a drop-off spot to complete the fulfillment of a pre-allocated order related to the first bundled tote; receiving, by the processor, new order information in which a type of a second bundled tote and a group order link each other; determining, with the processor, whether the type of the second bundled tote corresponds to a type of the first bundled tote; and displaying, by the processor, a first request information for using continuously the first bundled tote, if it corresponds.

In an embodiment of the present invention, the method may further include displaying, by the processor, a second request information for replacing the first bundled tote, if it does not correspond.

In order to solve the above technical problem, a system for fulfilling a group order according to an embodiment of present invention, the system may include a server configured to process information with the first processor; and a robot may be configured to communicate with the server, and to process information with a second processor, wherein the first processor is configured to: generate multiple order information in which one or more type of a first bundled tote and different group orders link each other respectively, and transmit a first request information for selecting at least one order information among the multiple order information to the robot, wherein the second processor is configured to: determine whether a type of the first bundled tote corresponds to a type of a second bundled tote loaded on the robot among the multiple order information, and select one group order among the group orders linked with the corresponding type of the second bundled tote and request allocation to the server when the type of the first bundled tote corresponds to the type of the second bundled tote.

In an embodiment of the present invention, the robot may further include a display, and the second processor may be further configured to control the robot to move to a drop-off spot to complete the fulfillment of a pre-allocated order, receive a second request information for selecting at least one order information among the multiple order information, determine whether the type of the first bundled tote corresponds to the type of a second bundled tote loaded on the robot among the multiple order information, select one group order among the group orders linked with the corresponding type of the second bundled tote and request allocation to the server when the type of the first bundled tote corresponds to the type of the second bundled tote, and display a third request information for using continuously the second bundled tote on the display.

The present invention has the effect of contributing to the minimization of an order fulfillment time by minimizing the time for replacing the bundled tote.

### BRIEF DESCRIPTION OF THE DRAWINGS

FIG. 1 shows an order fulfillment system using a bundled tote according to an embodiment of the present invention.

FIG. 2 shows a robot according to an embodiment of the present invention.

FIGS. 3A-3C show various types of bundled tote loaded on the robot.

FIG. 4 shows an order fulfillment method using the bundled tote according to a first embodiment of the present invention.

FIG. 5 shows in detail some components of the order fulfillment method using the bundled tote according to the first embodiment of the present invention.

FIG. 6 shows an order fulfillment method using the bundled tote according to a second embodiment of the present invention.

FIG. 7 shows an order fulfillment method using the bundled tote according to a third embodiment of the present invention.

FIG. 8 shows an order fulfillment method using the bundled tote according to a fourth embodiment of the present invention.

FIG. 9 shows in detail some components of the order fulfillment method using the bundled tote according to the fourth embodiment of the present invention.

### DETAILED DESCRIPTION OF THE EMBODIMENTS

The present invention may be subjected to various transformations and have various embodiments, and specific embodiments are illustrated in the drawings and will be described in detail. However, this is not intended to limit the present invention to specific embodiments, and it should be understood that they include all transformations, equivalents, and alternatives included in the spirit and technical scope of the present invention.

In the description of the present invention, a detailed description of related known techniques will be omitted when it is judged that the subject matter of the present invention may obscure.

Hereinafter, embodiments of the present invention will be described in detail with reference to the accompanying drawings.

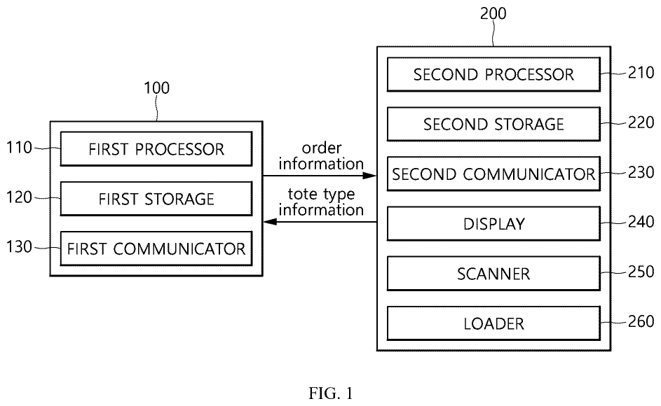

FIG. 1 shows an order fulfillment system using a bundled tote according to an embodiment of the present invention.

Referring to FIG. 1, the order fulfillment system using a bundled tote according to an embodiment of the present invention includes a server 100 and a robot 200.

The server 100 includes a first processor 110, a first storage 120, and a first communicator 130.

The first processor 110 is for performing information processing, and may include one or more processors.

The processor may include at least one of a central processing unit, a graphic processing unit, a microprocessor, and artificial intelligence dedicated processor, and the type and number of processors are not limited thereto as long as they perform the functions of the present invention.

The first storage 120 may record a program that is a set of data and executable instructions that may be read or written by the first processor 110.

The first storage unit 120 includes a non-volatile attribute storage capable of storing data (information) regardless of whether power is provided or not, and a volatile attribute memory in which data to be processed by a processor is loaded and data cannot be stored if power is not provided. The storage may include flash memory, hard-disc drive (HDD), solid-state drive (SSD), read only memory (ROM), and the like, and the volatile attributes memory may include a buffer, random access memory (RAM), and the like.

The first communicator 130 may transmit and receive information to and from the robot 200 under the control of the first processor 110.

The first communicator 130 may communicate with at least one of wired/wireless (LAN), wireless fidelity (Wi-Fi), Bluetooth, ZigBee, infrared data association (IrDa), near field communication (NFC), wireless broadband Internet (Wibro), shared wireless access protocol (SQAP), and RF communication methods, but the communication method need not be limited to the above embodiment.

Since the first storage 120 and the first communicator 130 may be controlled by the first processor 110, the operations by the first storage 120 or the first communicator 130 may be understood or described as being performed by the first processor 110.

The operations of the server 100 and its subcomponents will be described in detail in a description of the order fulfillment method using the bundled tote.

In the present invention, at least any order included in a group order may consist of a product or a bundle of products ordered by each customer. At least one order included in the group order may consist of a product or a bundle of products that were not picked if the product or bundle of products ordered by the customer was out of stock or could not be picked due to a robot malfunction. In the case where the order consists of a product or a bundle of products that have not been picked, the products ordered by different customers may be placed in one order.

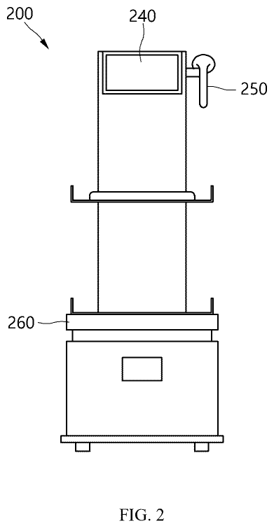

FIG. 2 shows a robot 200 according to an embodiment of the present invention.

Referring to FIGS. 1 and 2, the robot 200 includes a second processor 210, a second storage 220, a second communicator 230, a display 240, a scanner 250, and a loader 260.

The second processor 210 may control the second storage 220, the second communicator 230, the display 240, and the scanner 250.

Since the second storage 220, the second communicator 230, the display 240, and the scanner 250 may be controlled by the second processor 210, it may be understood or described that the operations by the second storage 220, the second communicator 230, the display 240, or the scanner 250 are performed by the second processor 210.

The second processor 210 is for performing information processing, and may include one or more processors.

The processor may include at least one of a central processing unit, a graphic processing unit, a microprocessor, and artificial intelligence dedicated processor, and the type and number of processors are not limited thereto as long as they perform the functions of the present invention.

The second storage 220 may record a program that is a set of data and executable instructions that may be read or written by the second processor 210.

The second storage unit 220 includes a non-volatile attribute storage capable of storing data (information) regardless of whether power is provided or not, and a volatile attribute memory in which data to be processed by a processor is loaded and data cannot be stored if power is not provided. The storage may include flash memory, hard-disc drive (HDD), solid-state drive (SSD), read only memory (ROM), and the like, and the volatile attributes memory may include a buffer, random access memory (RAM), and the like.

The second communicator 230 may transmit and receive information to and from the server 100 under the control of the second processor 210.

The second communicator 230 may communicate with at least one of wired/wireless (LAN), wireless fidelity (Wi-Fi), Bluetooth, ZigBee, infrared data association (IrDa), near field communication (NFC), wireless broadband Internet (Wibro), shared wireless access protocol (SQAP), and RF communication methods, but the communication method need not be limited to the above embodiment.

The display 240 may be installed at the upper end of the robot 200.

The display 240 may display various pieces of information related to the order fulfillment of the robot 200. For example, the display 240 may display replacement request information of the bundled tote 300. For example, the display 240 may display information indicating that the order may be fulfilled using the currently loaded bundled tote 300 as it is.

A worker in a warehouse collaborating with the robot 200 may pick up items, replace the bundled tote 300, unload the bundled tote 300 from the robot 200, and unload the items loaded on the tote 300 by referring to the information output on the display 240.

The scanner 250 scans an identification marker of the bundled tote 300, obtains identification information of the bundled tote 300, and provides the identification information to the second processor 210.

The second processor 210 may transmit the identification information of the bundled tote 300 obtained by the scanner 250 to the server 100 through the second communicator 200. When receiving the identification information of the bundled tote 300, the server 100 links the order assigned to the robot 200 that has transmitted it with the identification information of the bundled tote 300. The linked information may be used to match order information with the bundled tote 300 loaded with the items.

The identification marker may be at least one of a barcode and QR code. The identification marker need not be limited to the means illustrated.

The identification marker may be connected to the bundled tote 300 in various ways.

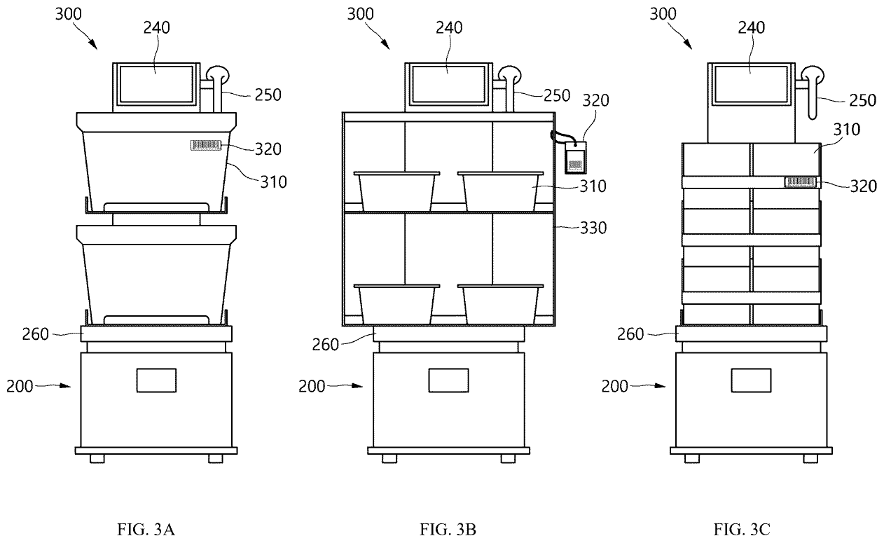

For example, the identification marker may be attached to an individual tote 310 of any one of the bundled tote 300 (see 320 in FIGS. 3A and 3C).

For example, the identification marker may be attached to or suspended from the frame 330 that supports the bundle tote 300 (see 320 in FIG. 3B).

The loader 260 provides a space in which the bundled tote 300 mounted.

The loader 260 may include a flat surface protruding from the front to a predetermined length.

Although not shown in the drawings, the loader 260 may include a weight sensor for detecting whether an item is loaded.

The operations of the robot 200 and its subcomponents will be described in detail in the description of the order fulfillment method using the bundled tote.

FIGS. 3A-3C show various types of bundled tote 300 loaded on the robot 200.

The different types of bundled tote 300 may be distinguished based on at least one of which: the number of individual totes 310 included in the bundled tote 300, the size of the individual totes 310, the color of the individual totes 310, and the frame type supporting the individual totes 310.

For example, the bundled tote 300 shown in FIG. 3A is a type including two large gray individual totes 310.

For example, the bundled tote 300 shown in FIG. 3B is a type in which four medium-sized red individual totes 310 are included and supported by a two-stage frame 330.

For example, the bundled tote 300 shown in FIG. 3C is a type in which a total of six small individual totes 310, two each of red, blue, and yellow is included.

Hereinafter, an order fulfillment method using the bundled tote executed by the order fulfillment system using the bundled tote will be described.

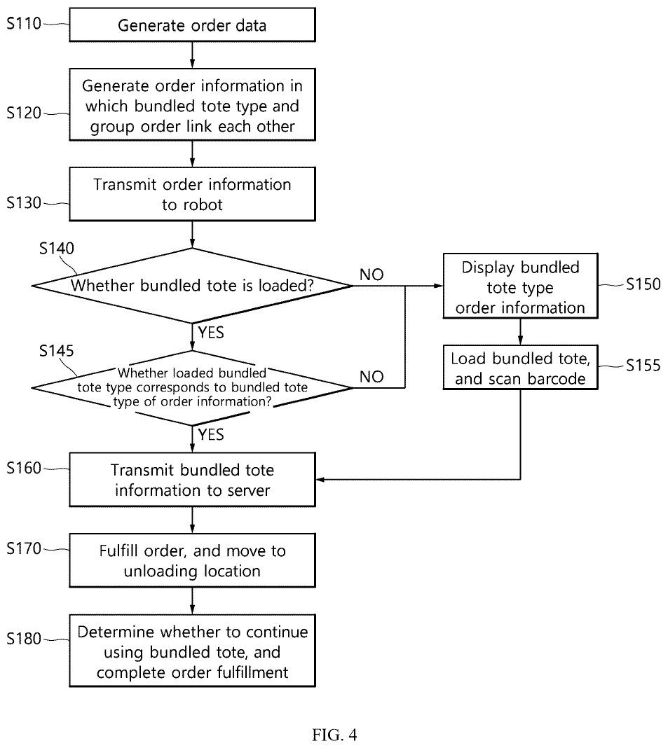

FIG. 4 shows an order fulfillment method using the bundled tote 300 according to a first embodiment of the present invention.

Referring to FIG. 4, in step S110, the server 100 generates order data. The generated order data may be stored in the first storage 120.

The order data may be transmitted from an external terminal that may be connected to the server 100 via a wired/wireless network.

The order data may include information input by an administrator of the server 100. The administrator may transmit information to be input to the server 100 through the external terminal. When a physical input interface is connected to the server 100, the administrator may input order data through the input interface.

The order data may be grouped into execution rounds according to the set criteria. For example, orders generated from 9:00 AM to 3:00 PM may be grouped into one round, orders generated from 3:00 PM to 9:00 AM the next day may be grouped into another round.

In step S120, the first processor 110 analyzes the order data to generate order information in which a bundled tote type and a group order linked each other.

In the analysis of the order data, the size of the items included in the order data, the number of the items, and the movement of the robot 200 moving to pick the items, and the like may be considered. The algorithm for analyzing the order data may be programmed and stored in the first storage 120, and may be executed by the first processor 110.

The group order may refer to a set of individual orders that may be fulfilled using a plurality of individual totes 310 groups. That is, the group order may be a set of individual orders that may be fulfilled using the bundled tote 300.

If the individual order is an order for one item, the group order that groups six orders may be fulfilled using the bundled tote 300 composed of six individual totes 310 that may hold one item.

Therefore, the group order is linked with the bundled tote type corresponding to the characteristics of the orders included in the group order. The fact that the group order and the bundled tote type link each other may mean a request for fulfilling the group order using the bundled tote 300 of the specified type.

The order information includes information on multiple orders and the bundled tote type to be used for the fulfillment of the orders.

The order information may be generated in plural, and the generated order information may be stored in the first storage 120.

In step S130, the first processor 110 transmits the order information to the robot 200 through the first communicator 130. In this time, the robot 200 may be any one robot 200 selected by the server 100 among a plurality of robots 200 that perform the order task in a warehouse.

In the first embodiment, the robot 200 fulfills one group order when receiving one order information.

The second processor 210 of the robot 200 may receive the order information through the second communicator 230. The order information may be stored in the second storage 220.

In step S140, the second processor 210 determines whether the bundled tote 300 is loaded on the robot 200.

Whether to be loaded in the bundled tote 300 may be determined by the second processor 210 as the information of the sensor that may be installed in the loader 260 is provided to the second processor 210.

Whether to be loaded in the bundled tote 300 may be determined by reading the bundled tote information previously scanned by the scanner 250 into the second storage 220 by the second processor 210.

In step S140, if it is determined that the bundled tote 300 is loaded, it proceeds to step S145 and if it is determined that the bundled tote 300 is not loaded, it proceeds to step S150.

In step S145, the second processor 210 may determine whether the type of the loaded bundled tote 300 corresponds to the bundled tote type of the order information. Corresponding may mean either being of the same type or including some identical elements (e.g., the number of individual totes 310). For example, if the number of individual totes is the same even if the color of the loaded bundled tote 300 and the color of the bundled tote of the order information are different, it may be determined as the corresponding bundled tote type.

In step S145, whether the type of the loaded bundled tote 300 corresponds to the bundled tote type of the order information may be determined by the first processor 110. In this case, the type information of the loaded bundled tote 300 may be transmitted to the server 100 in advance.

In step S145, if the type of the loaded bundled tote 300 corresponds to the bundled tote type of the order information, it proceeds to step S160, and if not, it proceeds to step S150.

In step S150, the second processor 210 outputs the bundled tote type of the order information on the display 240. At the same time, the second processor 210 may output information indicating that the bundled tote 300 of the type corresponding to the bundled tote type of the order information is requested to be loaded on the robot 200 on the display 240. The request information may be output by a speaker that may be installed in the robot 200.

When the bundled tote 300 is already loaded, the second processor 210 may output information indicating that the loaded tote should be replaced with the bundled tote 300 of the type corresponding to the bundled tote type of the order information on the display 240.

The worker near the robot 200 may identify the bundled tote type displayed on the display 240.

In step S155, the robot 200 may be loaded with the bundled tote 300 corresponding to the bundled tote type of the order information, and the identification marker may be scanned. The loading of the bundled tote 300 may be understood as a concept that includes the replacement. The loading of the bundled tote 300 may be performed by the worker around the robot 200.

The worker may operate the scanner 250 after loading the bundled tote 300 to scan the identification marker linked with the bundled tote 300.

If the position of the identification marker installed in the bundled tote 300 is always included within the scan range of the scanner 250, the identification marker may be automatically scanned when the bundled tote 300 is loaded on the robot 200 without the worker's action.

In step S160, the second processor 210 transmits the bundled tote information to the server 100 through the second communicator 230.

The bundled tote information may include identification information and type information of the bundled tote 300.

The identification information of the bundled tote 300 may be information that distinguishes the bundled tote 300 linked with the identification information from the other bundled tote 300.

When the bundled tote information is received by the first communicator 130, the first processor 110 may link the order information and bundled tote information each other and store them in the first storage 120.

The relationship between the order information and the bundled tote information is summarized again in chronological order as follows. \textcircled{1} In the server, order information is generated by linking the order group information and bundled tote type each other. At this time, although the currently loaded bundled tote may exist on the robot, the server does not consider the currently loaded bundled tote type on the robot at the time of order allocation. \textcircled{2} The server transmits the order information to the robot. This may mean that the group order is allocated to the robot to which the group order transmitted.

\textcircled{3} The robot continues to use the currently loaded bundled tote or replaces it with a new bundled tote in order to correspond to the bundled tote type included in the order information, and transmits the bundled tote information to the server so that the finally loaded bundled tote information is linked with the order information. At this point, the order information and the bundled tote information actually loaded on the robot link each other.

When the group order is transmitted to the robot, the robot outputs the bundled tote information included in the group order, and the worker may load the bundled tote corresponding to the group order onto the robot based on this, or when the bundled tote is currently loaded on the robot, the loaded bundled tote and the output bundled tote may be determined to be identical to each other, and if they are identical, they can be reused, and if they are not identical, the bundled tote loaded onto the robot may be unloaded and the bundled tote corresponding to the output bundled tote may be loaded onto the robot. Whether the loaded bundled tote and the bundled tote included in the group order are identical may be input by the worker's judgment, or the robot may autonomously determine based on the previously input bundled tote barcode information.

In step S170, the second processor 210 controls the robot 200 to fulfill the group order and move to the unloading location.

Fulfilling the group order may include moving the robot 200 to storage locations where items related to the group order may be picked.

In step S180, the first processor 110 and/or the second processor 210 determine whether to continue using the bundled tote 300 and complete the order fulfillment.

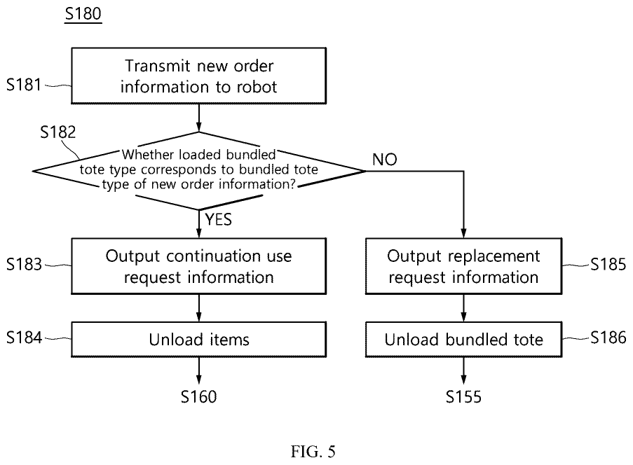

FIG. 5 shows the step S180 in detail.

Referring to FIG. 5, in step S181, the first processor 110 transmits new order information to the robot 200. The new order information may be transmitted when the first processor 110 obtains information on the idle status of the robot 200. According to an embodiment, the new order information may be transmitted at the request of the second processor 210. The request may mean that the fulfillment of the group order currently being fulfilled has reached a completion step and the next order is to be allocated.

The new order information also includes information in which the bundled tote type and the group order link each other.

The second processor 210 may receive the new order information and store it in the second storage 220.

In step S182, the second processor 210 determines whether the loaded bundled tote type corresponds to the bundled tote type of the new order information.

In case the loaded bundled tote type corresponds to the bundled tote type of the new order information, it proceeds to step S183 and if not, it proceeds to step S185.

In step S183, the second processor 210 outputs continuation use request information on the display 240.

The continuation use request information may include information indicating that the bundled tote 300 may be used to continue to fulfill the new order without replacing the bundled tote 300 and that only the items should be dropped off from the bundled tote 300.

In step S184, the items loaded on the bundled tote 300 are unloaded. The items may be unloaded by the worker in the unloading location.

When the items are unloaded, the worker may identify the linking information of the order and may identify which order the items are linked with. The linking information may be output on the display 240.

After unloading the items, the second processor 210 may transmit work completion information to the server 100.

The work completion information may be generated by the worker inputting it through the input interface included in the display 240 and then transmitted to the server 100.

After completing step S184, it returns to step S160 to perform work on a new order.

In step S185, the second processor 210 outputs replacement request information on the display 240.

The replacement request information may include request information indicating that the loaded bundled tote 300 should be unloaded and the other type of bundled tote 300 should be loaded, and information on the type of bundled tote to be replaced.

In step S186, the bundled tote 300 is unloaded. The unloading of the bundled tote 300 may be performed by the worker at the unloading location. The worker newly loads the bundled tote 300 of the type to be replaced to the robot 200.

After unloading the bundled tote 300, the second processor 210 may transmit the work completion information to the server 100.

The work completion information may be generated by the worker inputting it through the input interface included in the display 240 and then transmitted to the server 100.

After completing step S186, it returns to step S155 to perform work on a new order.

In the present invention, the replacement place of the bundled tote 300 may be an unloading location or a separately designated replacement place, but it may be preferable that the replacement of the bundled tote 300 is performed in the unloading location. The unloading location may placed at least one or more types of idle bundled tote 300.

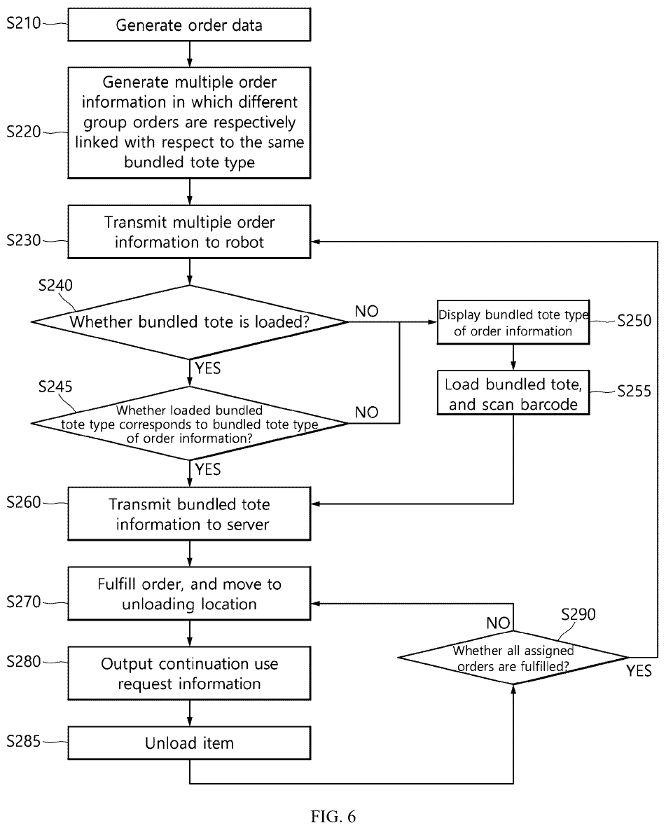

FIG. 6 shows an order fulfillment method using the bundled tote 300 according to a second embodiment of the present invention.

Referring to FIG. 6, in step S210, the server 100 generates order data. The generated order data may be stored in the first storage 120.

In step S220, the first processor 110 analyzes the order data to generate order information in which the bundled tote type and the group order link each other.

In the second embodiment, the first processor 110 includes multiple order information in which different group orders are respectively linked with respect to the same bundled tote type. Each of the order information includes information on the same tote type and information on different group orders.

For example, the plurality of order information may include a first group order using the first type bundled tote 300, a second group order using the first type bundled tote 300, and a third group order using the first type bundled tote 300.

In step S230, the first processor 110 transmits the multiple order information to the robot 200 through the first communicator 130. At this time, the robot 200 may be any one robot 200 selected by the server 100 among a plurality of robots 200 that perform the order task in a warehouse.

In the second embodiment, upon receiving multiple order information, the robot 200 fulfills all group orders included in the multiple order information.

The second processor 210 of the robot 200 may receive the order information through the second communicator 230. The order information may be stored in the second storage 220.

In step S240, the second processor 210 determines whether the bundled tote 300 is loaded on the robot 200. In step S240, if it is determined that the bundled tote 300 is loaded, it proceeds to step S250, and if it not, it proceeds to step S250.

In step S245, the second processor 210 may determine whether the type of the loaded bundled tote 300 corresponds to the bundled tote type of the order information. In step S245, if the type of the loaded bundled tote 300 corresponds to the bundled tote type of the order information, it proceeds to step S260, and if not, it proceeds to step S250.

In step S250, the second processor 210 outputs the bundled tote type of the order information on the display 240. At the same time, the second processor 210 may output information indicating that the bundled tote 300 of the type corresponding to the bundled tote type of the order information should be loaded on the robot 200 on the display 240. The request information may be output by a speaker that may be installed in the robot 200.

When the bundled tote 300 is already loaded, the second processor 210 may output information indicating that the loaded tote should be replaced with the bundled tote 300 of the type corresponding to the bundled tote type of the order information on the display 240.

The worker near the robot 200 may identify the bundled tote type displayed on the display 240.

In step S255, the robot 200 may be loaded with the bundled tote 300 corresponding to the bundled tote type of the order information, and the identification marker may be scanned. The loading of the bundled tote 300 may be understood as a concept that includes the replacement. The loading of the bundled tote 300 may be performed by the worker around the robot 200.

The worker may operate the scanner 250 after loading the bundled tote 300 to scan the identification marker linked with the bundled tote 300.

If the position of the identification marker installed in the bundled tote 300 is always included within the scan range of the scanner 250, the identification marker may be automatically scanned when the bundled tote 300 is loaded on the robot 200 without the worker's action.

In step S260, the second processor 210 transmits the bundled tote information to the server 100 through the second communicator 230 so that the plurality of order information and the loaded bundled tote information link each other.

When the bundled tote information is received by the first communicator 130, the first processor 110 may link the plurality of order information and bundled tote information each other and store them in the first storage 120.

In step S270, the second processor 210 controls the robot 200 to fulfill the group order and move to the unloading location. The group order performed herein means any one group order among the plurality of group orders.

In step S280, the second processor 210 outputs continuation use request information on the display 240.

In step S284, the items loaded on the bundled tote 300 are unloaded. The items may be unloaded by the worker in the unloading location.

After unloading the items, the second processor 210 may transmit work completion information to the server 100.

The work completion information may be generated by the worker inputting it through the input interface included in the display 240 and then transmitted to the server 100.

In step S290, the second processor 210 determines whether all assigned orders are fulfilled. If all the assigned orders are not fulfilled, it returns to step S270 to fulfill remaining group orders, and if all the assigned orders are fulfilled, it returns to step S230 to receive new order information.

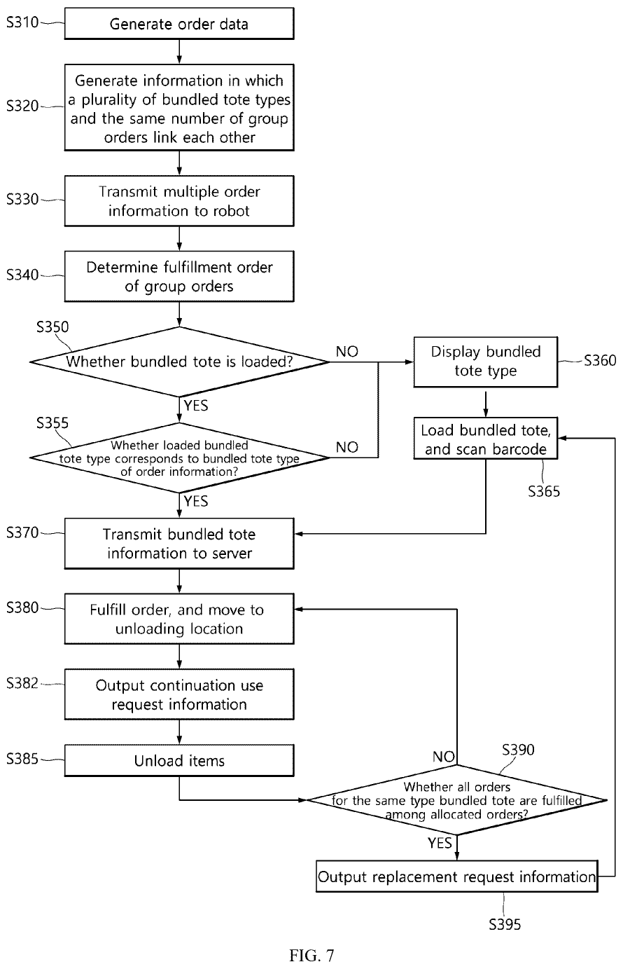

FIG. 7 shows an order fulfillment method using the bundled tote 300 according to a third embodiment of the present invention.

Referring to FIG. 7, in step S310, the server 100 generates order data. The generated order data may be stored in the first storage 120.

In step S320, the first processor 110 analyzes the order data to generate order information in which the bundled tote type and the group order link each other.

In the third embodiment, the first processor 110 includes multiple order information in which different group orders and one or more bundled tote types link each other. Each of the order information includes information on the same or different bundled tote types and information on different group orders.

For example, the multiple order information may include a first group order using the first type bundled tote 300, a second group order using the second type bundled tote 300, and a third group order using the second type bundled tote 300.

In step S330, the first processor 110 transmits the multiple order information to the robot 200 through the first communicator 130. At this time, the robot 200 may be any one robot 200 selected by the server 100 among a plurality of robots 200 that perform the order task in a warehouse.

In the third embodiment, upon receiving the multiple order information, the robot 200 fulfills all group orders included in the multiple order information.

The second processor 210 of the robot 200 may receive the order information through the second communicator 230. The order information may be stored in the second storage 220.

In step S340, the second processor 210 determines the fulfillment order of the group orders.

The order of fulfillment of the group orders may be determined so that at least two different group orders may be fulfilled sequentially using the same type of bundling tote 300.

For example, if the multiple order information includes a first group order using the first type bundled tote 300, a second group order using the second type bundled tote 300, and a third group order using the second type bundled tote 300, the order of fulfillment may be determined in the order of the first group order using the first type bundled tote 300, the second group order and the third group order using the second type bundled tote 300. Alternatively, in the above example, the second processor 210 may determine the execution order in the order of the second group order using the second type bundled tote 300, the third group order, and the first group order using the first type bundled tote 300.

In step S350, the second processor 210 determines whether the bundled tote 300 is loaded on the robot 200. In step S350, if it is determined that the bundled tote 300 is loaded, it proceeds to step S355, and if it not, it proceeds to step S360.

In step S355, the second processor 210 may determine whether the type of the loaded bundled tote 300 corresponds to the bundled tote type of the order information. In step S355, if the type of the loaded bundled tote 300 corresponds to the bundled tote type of the order information, it proceeds to step S370, and if not, it proceeds to step S360.

In step S360, the second processor 210 outputs the bundled tote type of order information on the display 240. At the same time, the second processor 210 may output information indicating that the bundled tote 300 of the type corresponding to the bundled tote type of the order information should be loaded on the robot 200 on the display 240. The request information may be output by a speaker that may be installed in the robot 200.

When the bundled tote 300 is already loaded, the second processor 210 may output information indicating that the loaded tote should be replaced with the bundled tote 300 of the type corresponding to the bundled tote type of the order information on the display 240.

The worker near the robot 200 may identify the bundled tote type displayed on the display 240.

In step S365, the robot 200 may be loaded with the bundled tote 300 corresponding to the bundled tote type of the order information, and the identification marker may be scanned. The loading of the bundled tote 300 may be understood as a concept that includes the replacement. The loading of the bundled tote 300 may be performed by the worker around the robot 200.

The worker may operate the scanner 250 after loading the bundled tote 300 to scan the identification marker matched with the bundled tote 300.

If the position of the identification marker installed in the bundled tote 300 is always included within the scan range of the scanner 250, the identification marker may be automatically scanned when the bundled tote 300 is loaded on the robot 200 without the worker's action.

In step S370, the second processor 210 transmits the bundled tote information to the server 100 through the second communicator 230 so that the loaded bundled tote information is linked with the multiple group orders that may be fulfilled with the same type of bundled tote 300 in the order in which the group orders may be continuously fulfilled using the same bundled tote 300.

When the bundled tote information is received by the first communicator 130, the first processor 110 may link the plurality of order information and bundled tote information each other and store them in the first storage 120.

In step S380, the second processor 210 controls the robot 200 to fulfill the group order and move to the unloading location. The group order performed herein means any one group order among the plurality of group orders.

In step S382, the second processor 210 outputs continuation use request information on the display 240.

In step S385, the items loaded on the bundled tote 300 are unloaded. The items may be unloaded by the worker in the unloading location.

After unloading the items, the second processor 210 may transmit work completion information to the server 100.

The work completion information may be generated by the worker inputting it through the input interface included in the display 240 and then transmitted to the server 100.

In step S390, the second processor 210 determines whether all orders for the same type bundled tote 300 have been fulfilled among all allocated orders. If all the allocated orders are not fulfilled, it returns to step S380 to fulfill the remaining group orders, and if all the allocated orders are fulfilled, it returns to step S365 to fulfill the remaining group orders for the bundled tote 300 of the type that is not the same as the type of the loaded bundled tote 300.

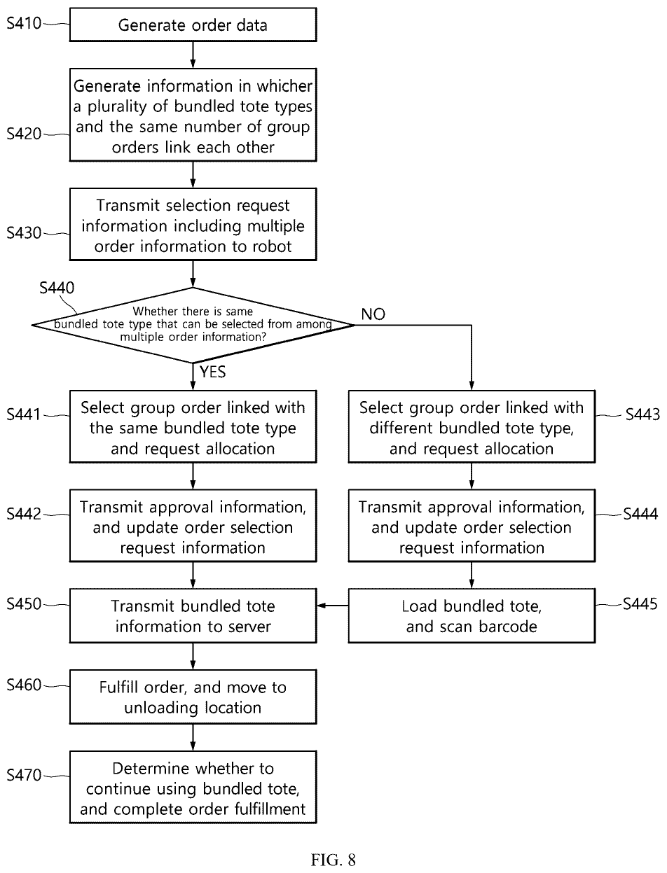

FIG. 8 shows an order fulfillment method using the bundled tote 300 according to a fourth embodiment of the present invention.

Referring to FIG. 8, in step S410, the server 100 generates order data. The generated order data may be stored in the first storage 120.

In step S420, the first processor 110 analyzes the order data to generate order information in which the bundled tote type and the group order link each other.

In the fourth embodiment, the first processor 110 includes multiple order information in which different group orders and one or more bundled tote types link each other. Each of the order information includes information on the same or different bundled tote types and information on different group orders.

In step S430, the first processor 110 transmits selection request information including the multiple order information to the robot 200 through the first communicator 130. At this time, the robot 200 may be at least one robot 200 selected by the server 100 among a plurality of robots 200 that perform the order task in a warehouse.

The selection request information may be information intended to request to select at least one piece of order information among the multiple order information.

The second processor 210 of the robot 200 may receive the selection request information through the second communicator 230.

In step S440, the second processor 210 determines whether there is a bundled tote type corresponding to the type of the bundled tote 300 currently loaded on the robot 200 among the multiple order information. If there is, it proceeds to step S441, and if not, it proceeds to step S443.

In step S441, the second processor 210 selects a group order linked with the bundled tote type corresponding to the type of the currently loaded bundled tote 300 and transmits information for requesting allocation to the server 100.

The first processor 110 receives the allocation request information.

In step S442, the first processor 110 transmits the approval information to the robot 200 that has transmitted the allocation request and updates the selection request information.

The update of the selection request information may mean excluding the order information allocated to the robot 200 from among the plurality of order information included in the selection request information. The updated selection request information may be transmitted to a robot 200 other than the robot 200 to which the allocation has been completed.

If the allocation request cannot be approved, the first processor 110 may transmit the approval reject information to the robot 200. In this case, the robot 200 may select an order other than the previously selected order.

The case where the allocation request cannot be approved may be, for example, a case where the order is already allocated by a request of the other robot 200.

In step S443, the second processor 210 selects a group order linked with a type of bundled tote different from the type of the currently loaded bundled tote 300 and transmits information for requesting allocation to the server 100.

The first processor 110 receives the allocation request information.

In step S444, the first processor 110 transmits the approval information to the robot 200 that has transmitted the allocation request and updates the selection request information.

The update of the selection request information may mean excluding the order information allocated to the robot 200 from among the plurality of order information included in the selection request information. The updated selection request information may be transmitted to a robot 200 other than the robot 200 to which the allocation has been completed.

If the allocation request cannot be approved, the first processor 110 may transmit the approval reject information to the robot 200. In this case, the robot 200 may select an order other than the previously selected order.

The case where the allocation request cannot be approved may be, for example, a case where the order is already allocated by a request of the other robot 200.

In step S445, the robot 200 may be loaded with the bundled tote 300 corresponding to the bundled tote type of the order information, and the identification marker may be scanned. The loading of the bundled tote 300 may be understood as a concept that includes the replacement. The loading of the bundled tote 300 may be performed by the worker around the robot 200.

The worker may operate the scanner 250 after loading the bundled tote 300 to scan the identification marker linked with the bundled tote 300.

If the position of the identification marker installed in the bundled tote 300 is always included within the scan range of the scanner 250, the identification marker may be automatically scanned when the bundled tote 300 is loaded on the robot 200 without the worker's action.

In step S450, the second processor 210 transmits the loaded bundled tote information to the server 100.

When the bundled tote information is received by the first communicator 130, the first processor 110 may link the allocated order information and the bundled tote information each other and store them in the first storage 120.

In step S470, the second processor 210 controls the robot 200 to fulfill the group order and move to the unloading location.

In step S470, the first processor 110 and/or the second processor 210 determine whether to continue using the bundled tote 300 and complete the order fulfillment.

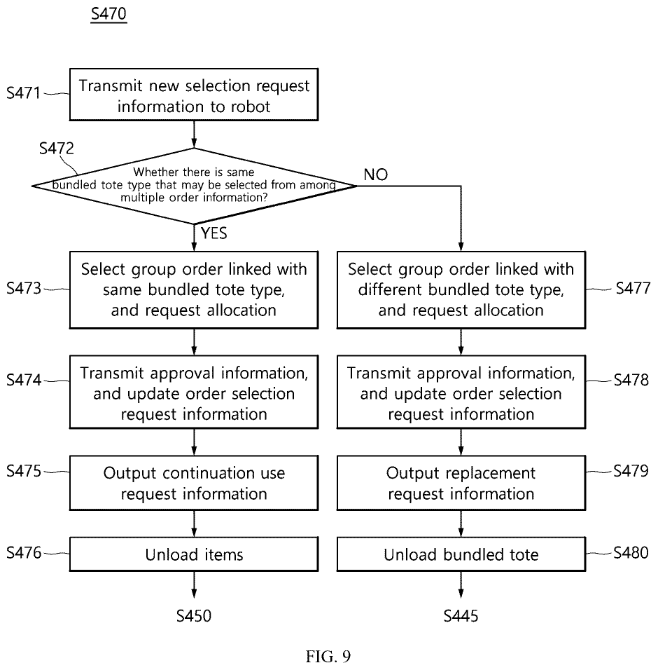

FIG. 9 shows step S470 in detail.

Referring to FIG. 9, in step S471, the first processor 110 transmits new selection request information to the robot 200. The new selection request information may be transmitted at the request of the second processor 210. The request may mean that the fulfillment of the group order currently being fulfilled has reached a completion step and the next order is to be allocated.

In step S472, the second processor 210 determines whether there is a bundled tote type of the same type that may be selected among the multiple order information included in the new selection request information. If there is, it proceeds to step S473, and if not, it proceeds to step S477.

In step S473, the second processor 210 selects a group order linked with the bundled tote type corresponding to the type of the currently loaded bundled tote 300 and transmits information for requesting allocation to the server 100.

The first processor 110 receives the allocation request information.

In step S474, the first processor 110 transmits the approval information to the robot 200 that has transmitted the allocation request and updates the selection request information.

In step S475, the second processor 210 outputs continuation use request information on the display 240.

The continuation use request information may include information indicating that the bundled tote 300 may be used to continue to fulfill the new order without replacing the bundled tote 300 and that only the items should be dropped off from the bundled tote 300.

In step S476, the items loaded on the bundled tote 300 are unloaded. The items may be unloaded by the worker in the unloading location.

When the items are unloaded, the worker may identify the matching information of the order and may identify which order the items are matched with. The matching information may be output on the display 240.

After unloading the items, the second processor 210 may transmit work completion information to the server 100.

The work completion information may be generated by the worker inputting it through the input interface included in the display 240 and then transmitted to the server 100.

After the completion of step S476, it returns to step S450 and performs the task for the newly allocated order.

In step S477, the second processor 210 selects a group order linked with a type of bundled tote different from the type of the currently loaded bundled tote 300 and transmits information for requesting allocation to the server 100.

The first processor 110 receives the allocation request information.

In step S478, the first processor 110 transmits the approval information to the robot 200 that has transmitted the allocation request and updates the selection request information.

The update of the selection request information may mean excluding the order information allocated to the robot 200 from among the plurality of order information included in the selection request information. The updated selection request information may be transmitted to a robot 200 other than the robot 200 to which the allocation has been completed.

In step S479, the second processor 210 outputs replacement request information on the display 240.

The replacement request information may include request information indicating that the loaded bundled tote 300 should be unloaded and the other type of bundled tote 300 should be loaded, and information on the type of bundled tote to be replaced.

In step S480, the bundled tote 300 is unloaded. The unloading of the bundled tote 300 may be performed by the worker at the unloading location. The worker newly loads the bundled tote 300 of the type to be replaced to the robot 200.

After unloading the bundled tote 300, the second processor 210 may transmit the work completion information to the server 100.

The work completion information may be generated by the worker inputting it through the input interface included in the display 240 and then transmitted to the server 100.

After the completion of step S480, it returns to step S455 and performs the task for the newly allocated order.

The terminology used in the present application is used merely to describe specific embodiments, and is not intended to limit the present invention. In the present application, it should be understood that the terms such as “to include” or “to have” are intended to designate the presence of features, numbers, steps, operations, components, parts or combinations thereof described in the specification, and do not exclude the presence or addition of one or more other features, numbers, steps, operations, components, parts or combinations thereof.

What is claimed is:

1. A method for fulfilling a group order in a system including a first processor of a server and a second processor of a robot, the method comprising:
generating, by the first processor, order information in which a type of a first bundled tote and the group order link each other;
transmitting, by the first processor, the order information to the robot;
determining, by at least one of the first processor and the second processor, whether a type of a second bundled tote corresponds to the type of the first bundled tote of the order information when the second bundled tote is loaded on the robot; and
fulfilling, by the second processor, the group order without replacing the second bundled tote loaded on the robot, when the type of the second bundled tote corresponds to the type of the first bundled tote of the order information.

2. The method of claim 1, further comprising:
transmitting, by the second processor, information on the second bundled tote to the server.

3. The method of claim 1, further comprising:
displaying, by the second processor, request information for using continuously the second bundled tote.

4. The method of claim 1, wherein the order information is multiple order information in which different group orders are respectively linked with respect to a same type of the first bundled tote,
the method further comprises:
transmitting, by the second processor, information on the second bundled tote to the server so that the multiple order information and the information on the second bundled tote link each other;
controlling, by the second processor, the robot to move to a drop-off spot to complete a fulfillment of any one group order; and
displaying, by the second processor, request information for using continuously the second bundled tote.

5. The method of claim 1, wherein the order information is multiple order information in which different group orders and one or more types of the first bundled tote link each other respectively,
the method further comprising:
receiving, by the second processor, the order information and determining a fulfillment order for a plurality of group orders so that the plurality of group orders are sequentially fulfilled using the same second bundled tote;
transmitting, by the second processor, information on the second bundled tote to the server so that the information on the second bundled tote is linked with the plurality of group orders which are fulfilled with the same type of the first bundled tote among the plurality of group orders in an order in which the group orders are sequentially fulfilled using the same second bundled tote;
controlling, by the second processor, the robot to move to a drop-off spot to complete a fulfillment of any one group order being fulfilled; and
displaying, by the second processor, request information for using continuously the second bundled tote.

6. A method for fulfilling a group order in a system including a processor of a robot loaded with a first bundled tote, the method comprising:
controlling, by the processor, the robot to move to a drop-off spot to complete a fulfillment of a pre-allocated order related to the first bundled tote;
receiving, by the processor, new order information in which a type of a second bundled tote and a group order link each other;
determining, with the processor, whether the type of the second bundled tote corresponds to a type of the first bundled tote; and
displaying, by the processor, first request information for using continuously the first bundled tote, when the type of the second bundled tote corresponds to the type of the first bundled tote.

7. The method of claim 6, further comprising:
displaying, by the processor, second request information for replacing the first bundled tote, when the type of the second bundled tote does not correspond to the type of the first bundled tote.

8. A system for fulfilling a group order, the system comprising:
a server configured to process information with a first processor; and
a robot configured to communicate with the server, and to process information with a second processor,
wherein the first processor is configured to:
generate multiple order information in which one or more type of a first bundled tote and different group orders link each other respectively, and
transmit first request information for selecting at least one order information among the multiple order information to the robot,
wherein the second processor is configured to:
determine whether a type of the first bundled tote corresponds to a type of a second bundled tote loaded on the robot among the multiple order information, and
select one group order among the group orders linked with the corresponding type of the second bundled tote and request allocation to the server when the type of the first bundled tote corresponds to the type of the second bundled tote.

9. The system of claim 8, wherein the robot further comprises a display, and
wherein the second processor is further configured to:
control the robot to move to a drop-off spot to complete a fulfillment of a pre-allocated order,
receive second request information for selecting at least one order information among the multiple order information,
determine whether the type of the first bundled tote corresponds to the type of the second bundled tote loaded on the robot among the multiple order information,
select one group order among the group orders linked with the corresponding type of the second bundled tote and request allocation to the server when the type of the first bundled tote corresponds to the type of the second bundled tote, and
display third request information for using continuously the second bundled tote on the display.
